(19) United States
(12) Patent Application Publication
(10) Pub. No.: US 2013/0119210 A1
(43) Pub. Date: May 16, 2013

(54) Self Gap Reducing Stand For A Plurality Of Monitors

(71) Applicant: Jerry Moscovitch, Toronto (CA)

(72) Inventor: Jerry Moscovitch, Toronto (CA)

(21) Appl. No.: 13/812,409

(22) PCT Filed: Jul. 28, 2011
(86) PCT No.: PCT/CA11/00870

§ 371 Date: Jan. 25, 2013

Related U.S. Application Data
(60) Provisional application No. 61/368,344, filed on Jul. 28, 2010.

(51) Int. Cl. F16M 11/00

(52) U.S. Cl. CPC F16M 11/00
USPC 248/122.1; 248/121

(57) ABSTRACT

Described herein is a system for supporting a plurality of computer monitors. The system includes a support column and a cantilevered structure that extends from either side of the support column. The system further includes a first mounting component for mounting a first monitor to one side of the cantilevered structure, and a second mounting component for mounting a second monitor to an opposite side of the cantilevered structure. In operation, gravity exerts forces on the first mounting component and the first monitor mounted thereto that cause the first monitor to assume a lower position that is closer to the second monitor.

### FIELD OF THE INVENTION

This invention relates to support structures for computer monitors, and more specifically to support structures for supporting a plurality of monitors.

### BACKGROUND OF THE INVENTION

The use of multi-monitor computer systems, where more than one monitor is coupled to a computer and supported by a support structure has increased in recent years. A multi-monitor computer system can be used to create the illusion of a larger screen, thereby allowing a user to view a large single file over several displays. Alternatively, the user may view individual applications on individual screens (for example, one screen may display a Web Browser and a second a spreadsheet of financial data).

With multi-monitor computer systems having a pair of side-by-side monitors, it is usually desirable to minimize the gap between monitors to better view the screens. Thus, any system or method that allows for this gap to be minimized would be welcome.

### SUMMARY OF THE INVENTION

Described herein is a system for supporting a plurality of computer monitors. The system includes a support column and a cantilevered structure that extends from either side of the support column. The system further includes a first mounting component for mounting a first monitor to one side of the cantilevered structure. The one side of the cantilevered structure includes a first rail, and the first mounting component includes at least one rolling member that rides on the first rail. The first rail is angled to bias the first monitor towards the lower position under the influence of gravity.

The system also includes a second mounting component for mounting a second monitor to an opposite side of the cantilevered structure. The opposite side of the cantilevered structure includes a second rail, and the second mounting component includes at least one rolling member that rides on the second rail. The second rail is angled to bias the second monitor towards the lower position under the influence of gravity.

In operation, gravity exerts forces on the first mounting component and the first monitor mounted thereto, and on the second mounting component and the second monitor mounted thereto that cause the first monitor and the second monitor to approach each other. The result is that the gap between the monitors is automatically reduced or eliminated.

### BRIEF DESCRIPTION OF THE DRAWINGS

The various advantages of the invention will become apparent to one skilled in the art by reading the following specification and by referencing the following drawings.

FIG. 1A depicts a system for supporting a pair of computer monitors shown held apart;

FIG. 1B depicts the system of FIG. 1A after the monitors have been released and gravity has forced the monitors together;

FIG. 1C shows a close up of the first mounting component of FIG. 1A having the first rail and the at least one rolling member;

FIG. 2A depicts another embodiment of a system for supporting a pair of computer monitors shown held apart;

FIG. 2B shows the system of FIG. 2A after the monitors have been released and gravity has forced the monitors together;

FIG. 3A depicts yet another embodiment of a system for supporting a pair of computer monitors shown held apart;

FIG. 3B shows the system of FIG. 3A after the monitors have been released and gravity has forced the monitors together.

### DETAILED DESCRIPTION OF INVENTION

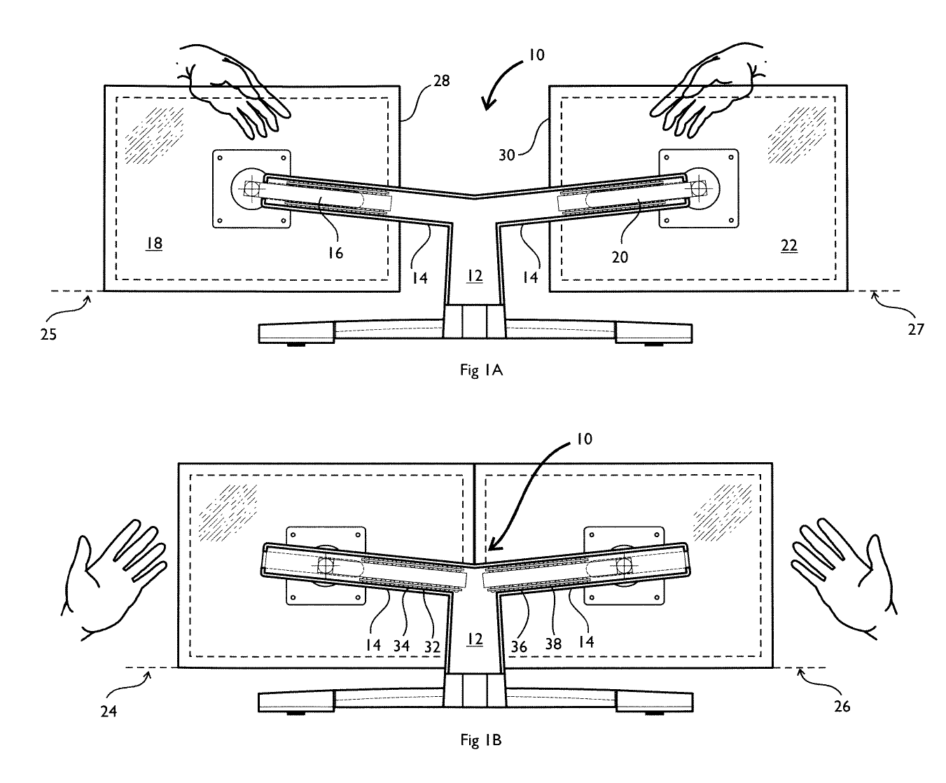

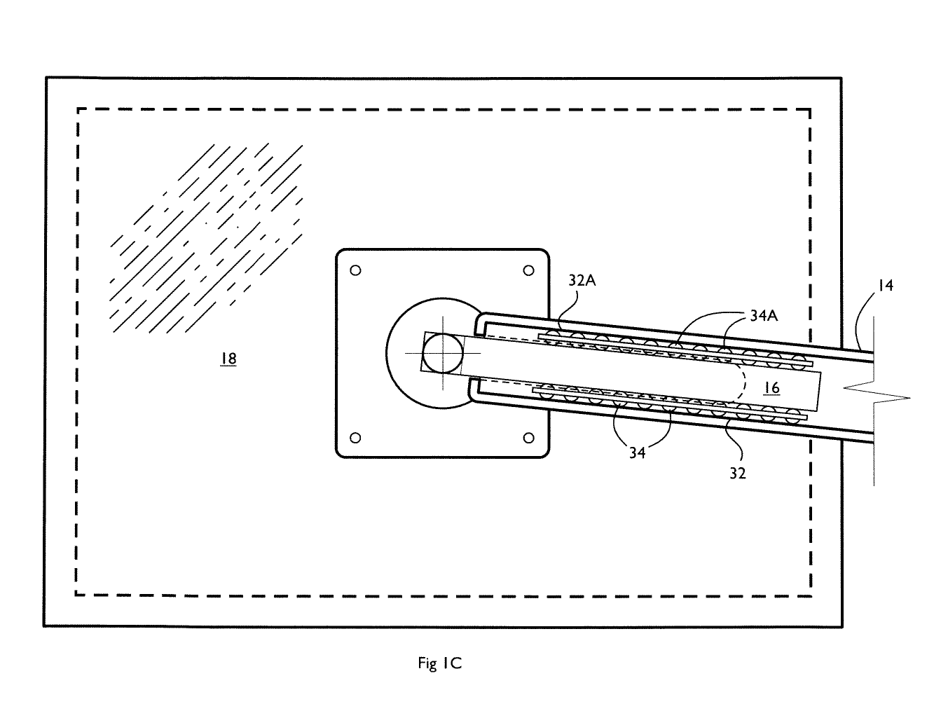

FIGS. 1A and 1B show a system 10 for supporting a plurality of computer monitors. The system 10 includes a support column 12, and a cantilevered structure 14 that extends from either side of the support column 12. A first mounting component 16 serves to mount a first monitor 18 on one side of the cantilevered structure 14. Likewise, a second mounting component 20 serves to mount a second monitor 22 to an opposite side of the cantilevered structure 14.

In operation, gravity exerts a first force on the first mounting component 16 that causes the first mounting component 16 to assume a lower position 24 (see FIG. 1B) that is both closer to the second monitor 22 and lower than an initial, higher position 25 (see FIG. 1A).

Likewise, gravity exerts a second force on the second mounting component 20 that causes the second mounting component 20 to assume a lower position 26 (see FIG. 1B) that is both closer to the first monitor 18 and lower than a higher position 27 (see FIG. 1A).

In the lower position 24 of the first monitor and the lower position 26 of the second monitor 22, the monitors 18 and 22 are close together. The positions 25 and 27 obtain when the monitors 18 and 22 are separated.

In FIG. 1A, hands hold the monitors 18 and 22 apart. After releasing them, the monitors 18 and 22 assume their respective lower positions 24 and 26 under the influence of gravity, as shown in FIG. 1B. When the monitors 18 and 22 are in their lower positions 24 and 26 shown FIG. 1B, the monitors 18 and 22 are in contact at their respective edges 28 and 30.

In the embodiment shown in FIGS. 1A and 1B, the one side of the cantilevered structure 14 includes a first rail 32. The first mounting component 16 includes at least one rolling member 34 (for example, a ball bearing or wheel) that rides on the first rail 32. The first rail 32 is angled to bias the first mounting component 16 towards the lower position 24 under the influence of gravity. Likewise, the other side of the cantilevered structure 14 includes a second rail 36. The second mounting component 20 includes at least one rolling member 38 that rides on the second rail 36.

FIG. 1C shows a close up of the first mounting component 16 having the first rail 32 and the at least one rolling member 34. In FIG. 1C, there are two first rails 32, 32A, one above the other, and two respective lines of ball bearings 34, 34A, one above the other. The ball bearings 34, 34A, which are part of the first mounting component 16, roll along their respective rails 32, 32A and help to eliminate any gap between the first monitor 18 and the second monitor 22. Elimination of the gap is achieved automatically because the rails 32, 32A are biased so that the at least one rolling member 34, 34A tends to roll down the rails. A mirror image, similar structure is present at the second mounting component 20. In operation, gravity exerts forces on the first mounting component 16 and the first monitor 18 mounted thereto, and gravity exerts forces on the second mounting component 20 and the second monitor 22 mounted thereto. If the monitors 18 and 22 are not in their respective lower positions 24 and 26, the monitors 18 and 22 will consequently translate downwards and towards each other as the rolling members 34, 38 roll down their respective rails 32, 36. The result is that the monitors automatically reduce the gap therebetween under the influence of gravity.

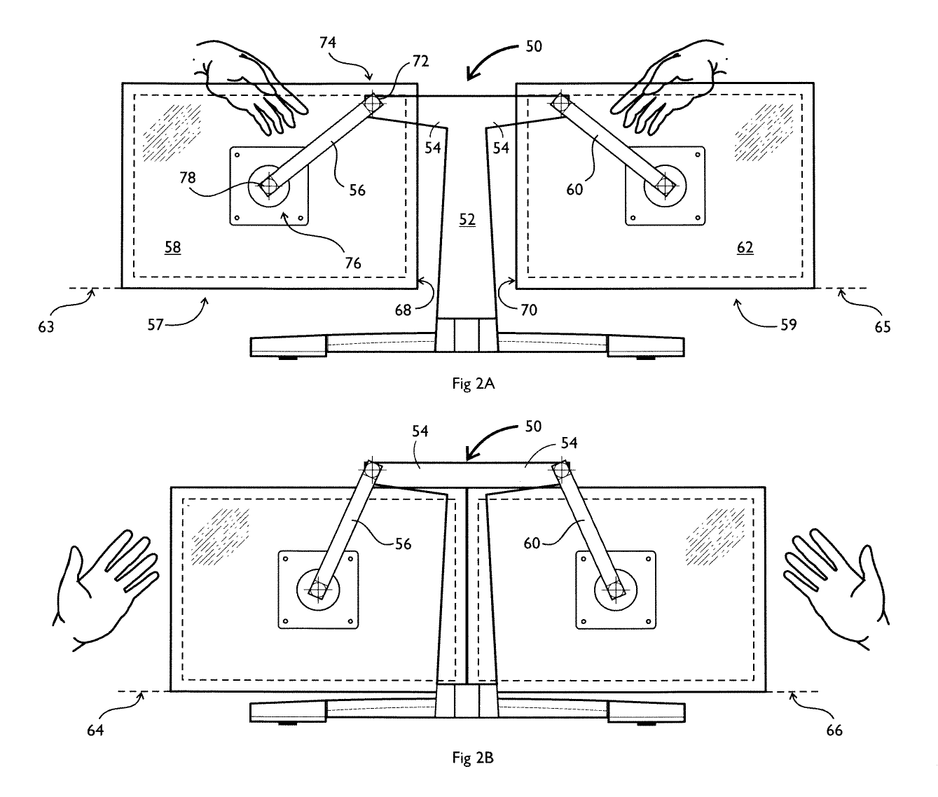

FIGS. 2A and 2B show another embodiment of a system 50 for supporting a plurality of computer monitors. The system 50 includes a support column 52, and a cantilevered structure 54 that extends from either side of the support column 52. A first mounting component 56 serves to mount a first monitor 58 on one side 57 of the cantilevered structure 54. Likewise, a second mounting component 60 serves to mount a second monitor 62 to an opposite side 59 of the cantilevered structure 54.

In operation, gravity exerts a first force on the first mounting component 56 that causes the first mounting component 56 to assume a lower position 64 than the initial position 63. At the lower position 64, the first monitor 58 is closer to the second monitor 62. Likewise, gravity exerts a second force on the second mounting component 60 that causes the second mounting component 60 to assume a lower position 66 than the initial position 65. At the lower position 66, the second monitor 62 is closer to the first monitor 58.

In FIG. 2A, hands hold the monitors 58 and 62 apart. After releasing them, the monitors 58 and 62 assume their respective lower positions 64 and 66 under the influence of gravity, as shown in FIG. 2B. In FIG. 2B, the monitors 58 and 62 are in their lower positions 64 and 66 when the monitors 58 and 62 come into contact at their respective edges, 68 and 70.

In the embodiment shown in FIGS. 2A and 2B, at the one side 57, the cantilevered structure 54 is connected to the first mounting component 56 via a hinge 72 at one end 74 of the first mounting component 56. At an opposite end 76 of the first mounting component 56, the first monitor 58 is connected to the first mounting component 56 via another hinge 78.

The hinge 72 allows the first mounting component 56 to rotate from the configuration shown in FIG. 2A, where the monitors 58 and 62 are apart, to the lower position 64. Similar structure and function pertain for the second mounting component 60 at the opposite side 59 of the cantilevered structure 54 that allows the second mounting component 60 to rotate from the configuration shown in FIG. 2A, where the monitors 58 and 62 are apart, to the lower position 66. In the lower positions 64 and 66 of the first and second mounting components 56 and 60, the monitors 58 and 62 are in contact at their edges 68 and 70.

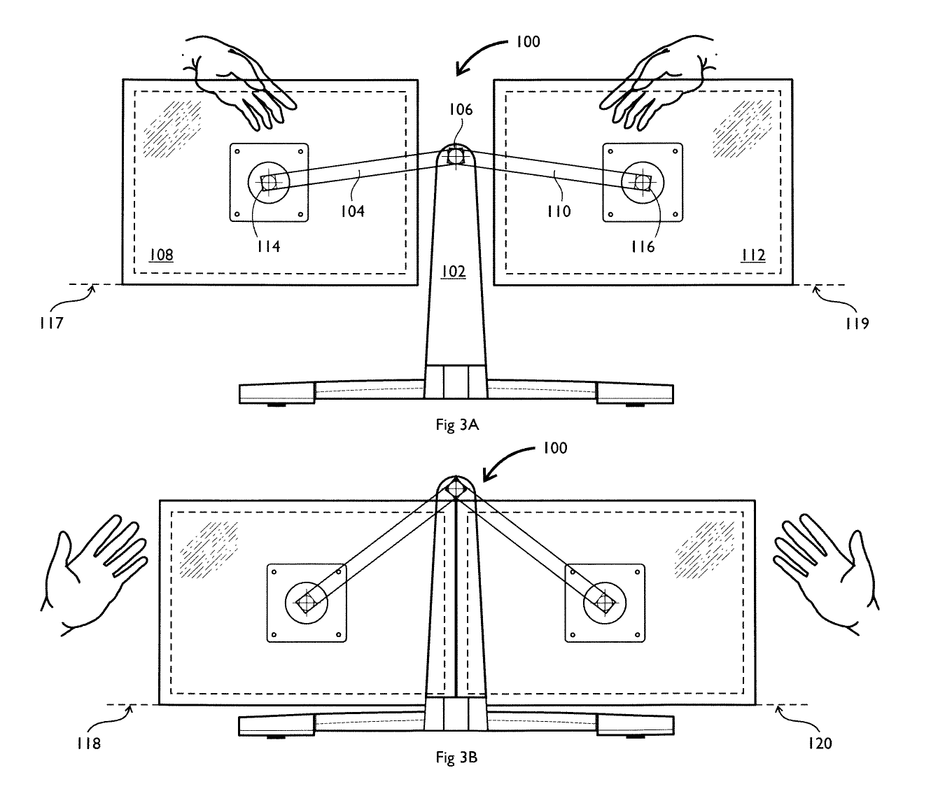

FIGS. 3A and 3B depict yet another embodiment of a system 100 for supporting a plurality of computer monitors. The system 100 includes a central support structure 102. A first arm 104 is attached via a hinge assembly 106 to the central support structure 102 for supporting a first monitor 108 on one side of the central support structure 102. Likewise, a second arm 110 is attached via the hinge assembly 106 to the central support structure 102 for supporting a second monitor 112 on an opposite side of the central support structure 102.

The system 100 further includes a first mounting component 114 for mounting the first monitor 108 to the first arm 104, and a second mounting component 116 for mounting the second monitor 112 to the second arm 110.

In operation, gravity exerts forces on the first monitor 108, the first mounting component 114 and the first arm 104 that cause the first monitor 108 to assume a lower position 118 than the initial position 117. In the lower position 118, the first monitor 108 is closer to the second monitor 112. Likewise, gravity exerts forces on the second monitor 112, the second mounting component 116 and the second arm 110 that cause the second monitor 112 to assume a lower position 120 than the initial position 119. In the lower position 120, the second monitor 112 is closer to the first monitor 108.

It should be understood that while the figures described above contain exactly two monitors, the inventor contemplates that the principles of the present invention can be applied to support structures for more than two monitors.

Advantageously, the embodiments described above are designed to automatically reduce the gap between adjacent monitors under the influence of gravity. The embodiments described above are exemplary only and are not meant to limit the scope of the invention, which is at least as broad as the following claims.

What is claimed is:

1. A system for supporting a plurality of computer monitors, the system comprising:
a support column;
a cantilevered structure that extends from either side of the support column;
a first mounting component for mounting a first monitor to one side of the cantilevered structure; and
a second mounting component for mounting a second monitor to an opposite side of the cantilevered structure, wherein, in operation, gravity exerts forces on the first mounting component and the first monitor mounted thereto that cause the first monitor to assume a lower position that is closer to the second monitor.

2. The system of claim 1, wherein:
the one side of the cantilevered structure includes a first rail; and
the first mounting component includes at least one rolling member that rides on the first rail, such that the first rail is angled to bias the first monitor towards the lower position under the influence of gravity.

3. The system of claim 2, wherein, in operation, gravity exerts forces on the second mounting component and the second monitor mounted thereto that cause the second monitor to assume a lower position that is closer to the first monitor.

4. The system of claim 3, wherein:
the opposite side of the cantilevered structure includes a second rail; and
the second mounting component includes at least one rolling member that rides on the second rail, such that the second rail is angled to bias the second monitor towards the lower position under the influence of gravity.

5. The system of claim 4, wherein, in the lower position of the first monitor and in the lower position of the second monitor, the first monitor and the second monitor are in contact.

6. The system of claim 4, further comprising a base attached to the support column, said base adapted to rest on a horizontal surface.

7. A system for supporting a plurality of computer monitors, the system comprising:
a central support structure;
a first arm attached via a hinge assembly to the central support structure for supporting a first monitor on one side of the central support structure;
a second arm attached via the hinge assembly to the central support structure for supporting a second monitor on an opposite side of the central support structure;
a first mounting component for mounting the first monitor to the first arm; and
a second mounting component for mounting the second monitor to the second arm, wherein, in operation, gravity exerts forces on the first monitor, the first mounting component and the first arm that cause the first monitor to assume a lower position that is closer to the second monitor.

8. The system of claim 7, wherein, in operation, gravity exerts forces on the second monitor, the second mounting component and the second arm that cause the second monitor to assume a lower position that is closer to the first monitor.

9. The system of claim 8, wherein, in the lower position of the first monitor and in the lower position of the second monitor, the first monitor and the second monitor are in contact.

10. The system of claim 9, further comprising a base attached to the support column, said base adapted to rest on a horizontal surface.
